(19) United States
(12) Patent Application Publication
(10) Pub. No.: US 2016/0173273 A1
(43) Pub. Date: Jun. 16, 2016

(54) PROCESS PARTIAL RESPONSE CHANNEL

(71) Applicant: HEWLETT PACKARD ENTERPRISE DEVELOPMENT L.P., Houston, TX (US)

(72) Inventors: Rafel Jibry, Bristol (GB); Robert Morling, Bristol (GB); Peter Walsh, Bristol (GB); Christopher Williams, Bristol (GB)

(21) Appl. No.: 14/908,535

(22) PCT Filed: Jul. 30, 2013
(86) PCT No.: PCT/US13/52668

§ 371 Date: Jan. 28, 2016

(51) Int. Cl. H04L 7/04; H04L 27/20

(52) U.S. Cl. CPC H04L 7/04; H04L 27/20

(57) ABSTRACT

Techniques for processing a partial response channel are disclosed. A segment of the signal is matched to one or more of a set of signal patterns. The set of the signal patterns is changed for a subsequent segment of the signal.

### BACKGROUND

Data processing systems are used in acquiring digital signals from an analog data source.

### BRIEF DESCRIPTION OF THE DRAWINGS

The accompanying drawings illustrate various examples and are a part of the specification. The illustrated examples are examples and do not limit the scope of the claims. Throughout the drawings, identical reference numbers designate similar, but not necessarily identical elements.

FIG. 1 is a block diagram of a signal timing recovery system according to various examples;

FIG. 2 is a schematic diagram illustrating elements of a magnetic tape data storage system, according to various examples;

FIG. 3 is a block diagram of an example data stream encoded on a magnetic tape;

FIGS. 4a-4c are schematic diagrams illustrating states in a signal timing recovery system according to various examples; and,

FIGS. 5a-5c are schematic diagrams illustrating data being read from an analog data source;

FIG. 6 is a flow diagram depicting steps taken to implement various examples.

The same part numbers designate the same or similar parts throughout the figures.

### DETAILED DESCRIPTION

In certain data processing systems, a signal timing recovery system may be used in acquiring a digital output from an analog data source. In certain systems, high data density in the analog data source affects reliability of signal timing recovery by methods such as peak detection. In certain systems, data channels referred to as “partial response” (PR) data channels are utilized in order to increase data density. In partial response data channels, a signal may comprise the linear summation of contributions from a number of adjacent data bits and the response to each data bit extends over multiple bit periods For example, in a class 4 partial response (PR4) channel, the response extends over 2 bit periods. In an extended class 4 partial response (EPR4) channel, the response extends over 3 bit periods. One difficulty with partial response data channels is that data bit transitions are close together and methods such as peak detection are not able to differentiate data bits.

In recovering digital data from partial response channels, even though the input signal from the analog data source may be non-ideal, a determination is made as to which of a number of ideal amplitudes of the input signal corresponds to the input signal at sampling times. The determined ideal amplitude is used in components of a read system such as in determining phase and/or gain error terms, for feeding back in an attempt to obtain or maintain synchronization of the system clock with the input signal and to track amplitude variations of the input signal.

In certain timing recovery systems for partial response data channels, signal pattern sequence matching may be used as part of a process to track phase and frequency variations in the data channel from which the error terms may be determined. A problem with pattern sequence matching is that higher order (the order referring to the number of bit periods over which the response extends) partial response channels present a significantly more complicated set of possible transitions between adjacent bit times (often depicted as an eye diagram) from which to qualify patterns.

One difficulty is that as the size and complexity of the eye diagram increases, it becomes more time consuming to identify the most likely pattern sequence. One problem is that if signal timing is not correctly recovered, there may be miss-recognition of bit positioning or bit values during data recovery.

One difficulty in higher order partial response read channels, such as an EPR4 channel, is that signals read from the analog source such as a magnetic tape may have relatively large and rapid phase and frequency variations that can be difficult to track in comparison to those in other recordable media such as hard disk drives. Typical problems include a reduction in speed of recovery of data as data density increases which may negate benefits of the increased data density. One problem is that if data recovery rates do not match or exceed the rate of incoming samples, there is a risk of buffer overflow and loss of data. Another problem is that the longer it takes to identify phase or frequency variations, the longer these will be present and impacting the data channel

Accordingly, various examples described herein may provide a system that enables improved timing recovery from a partial response channel. In an example of the disclosure, a system comprises an input to receive a signal from a partial response channel; a matching unit to match one or more of a set of signal patterns to a segment of the signal; and a controller to change the availability of one or more of the signal patterns of the set of signal patterns to the matching unit for a subsequent segment of the signal.

Advantages of the examples described herein may include that the number of possible signal patterns to be considered when performing timing recovery can be reduced. An advantage of reducing the number of signal patterns is that the search space to be considered is reduced. An advantage of reduced search space is that less processing is needed to classify a signal and recover timing and, as a result, time to process signals reduces. Another advantage is that invalid signal patterns may be excluded from the search space and the possibility of matching a signal pattern against an invalid signal pattern is avoided. Another advantage is that signal patterns to deal with certain situations or signal conditions may be enabled as and when it is determined their contribution would be of benefit and disabled when their contribution would be potentially detrimental or disruptive to the processing and/or eventual output. For example, certain patterns may be strongest when the signal is near-phase and ineffective otherwise. Similarly, certain patterns may be strongest when a signal is off-phase and ineffective otherwise. In such circumstances, the patterns could be enabled only when the phase of the signal would make them worthwhile.

Another advantage is that operation of the timing recovery system may be dynamically customized or configured during operation to take into account factors such as the specific fields in the signal read from the analog data source, limiting available patterns to be matched to those in a potential expected sequence.

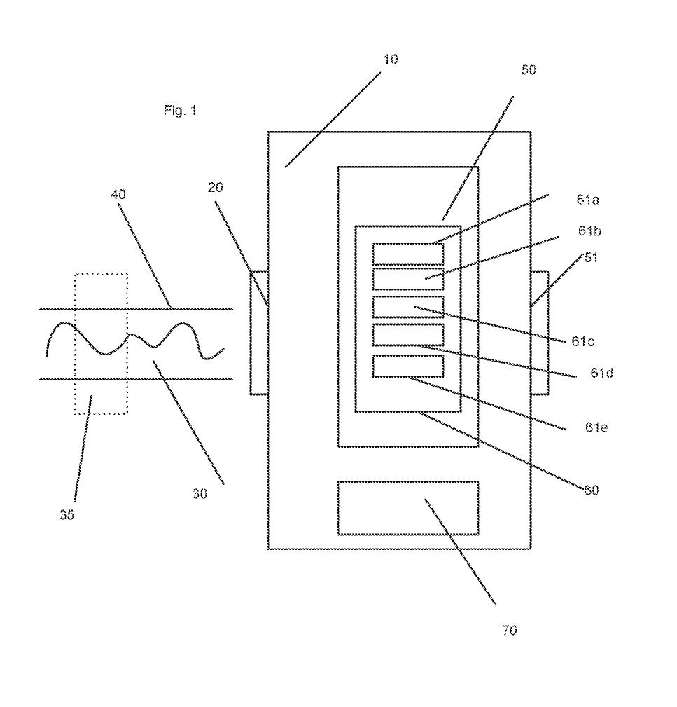

FIG. 1 is a block diagram of a system according to various examples. FIG. 1 includes particular components, modules, etc. according to various examples. However, in different examples, more, fewer, and/or other components, modules, arrangements of components/modules, etc. may be used according to the teachings described herein. In addition, various components, modules, etc. described herein may be implemented as one or more electronic circuits, software modules, hardware modules, special purpose hardware (e.g., application specific hardware, application specific integrated circuits (ASICs), embedded controllers, hardwired circuitry, Field Programmable Gate Arrays (FPGA), etc.), or some combination of these.

FIG. 1 shows a system 10 including an input 20, a matching unit 50 and a controller 70. In one example, the input 20 receives a signal 30 from a partial response channel 40. In one example, the signal is received over time by the input 20 and is processed as a sequence of signal segments 35, each subsequent signal segment being advanced along the signal by a stepping amount that is less than the width of the segment such that each current segment includes part of the immediately prior segment.

In one example, the matching unit 50 matches one or more of a set 60 of signal patterns 61a-61e to the current segment 35 of the signal 30. In one example, each signal pattern corresponds to an expected signal pattern that may be received in a signal segment 35 at the input 20. Example signal patterns are discussed in more detail below. In one example, the signal pattern includes or identifies signal timing information for a matched signal segment.

In one example, the controller 70 changes the availability of one or more of the signal patterns 61a-61e of the set 60 of signal patterns to the matching unit 50 for a subsequent segment of the signal. For example, a signal pattern 61a that was available to be matched against a current signal segment 35 may be disabled or otherwise have its influence inhibited for one or more subsequent signal segments.

In one example, the matching unit 50 attempts to match each segment as it is advanced along the signal to signal patterns of the set 60 that are available.

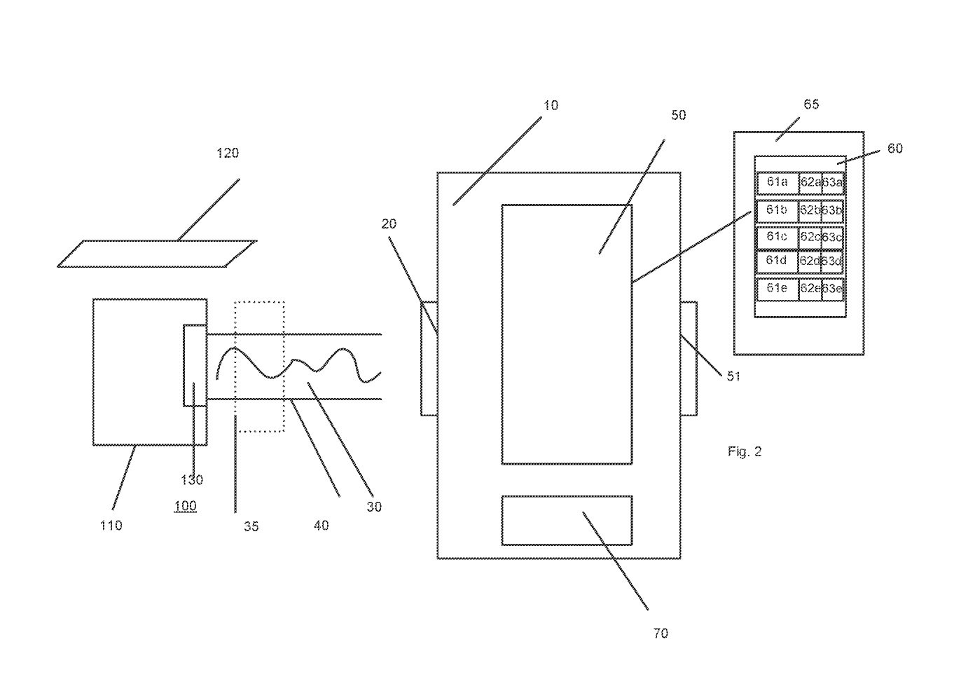

FIG. 2 is a schematic diagram illustrating elements of a magnetic tape data storage system, according to various examples. FIG. 2 includes particular components, modules, etc. according to various examples. However, in different examples, more, fewer, and/or other components, modules, arrangements of components/modules, etc. may be used according to the teachings described herein. In addition, various components, modules, etc. described herein may be implemented as one or more electronic circuits, software modules, data structures, encoded data, files, data streams hardware modules, special purpose hardware (e.g., application specific hardware, application specific integrated circuits (ASICs), embedded controllers, hardwired circuitry, Field Programmable Gate Arrays (FPGA), etc.), or some combination of these.

FIG. 2 shows a magnetic tape data storage system 100, for example a Linear-Tape Open (LTO) type magnetic tape data storage system. In one example, the magnetic tape data storage system 100 includes a read head 110 having read elements are aligned (in the case of LTO systems by use of servo tracks on the tape) to data tracks of data bands of a magnetic tape 120 being passed across the head. The read head 110 generates an analog output 30 in the form of a partial response data channel which is typically subject to electrical noise and inter-symbol interference.

In one example, the partial response data channel is processed by a signal processing unit 130 to equalize the signal to a frequency response analog output 30.

In one example, the read head 110 is communicatively coupled to a timing recovery system 10 and the analog output 30 of the read head 110 is communicated to an input 20 of the timing recovery system 10.

In one example, the timing recovery system 10 includes a matching unit 50. In one example, the matching unit 50 applies a moving, fixed length, window to the analog signal being received at the input 20 to process the analog signal as a time-ordered series of signal samples 35. Because the analog signal is a partial response signal, each signal sample extends over multiple bit periods. In one example, the matching unit 50 references a set 60 of signal patterns 61a-61e. In one example, the signal patterns are encoded in a data repository 65. In one example, each signal pattern encodes expected signal values and transitions for a pattern of the multiple bit length. For example, a pattern for an EPR-4 signal may be of the form {0, 4, 0} representing the ideal signal amplitudes and timing that should be matched against.

In one example, the signal sample 35 is sub-sampled using a slicer into a number of sub-samples corresponding to the expected bit length and a digital value determined for each sub-sample before they are matched against the signal patterns by the matching unit 50. The expected presence of noise and inter symbol interference in the signal sample is taken into account. For example, a signal sample corresponding to values {0.1, 3.2, 0.2} may be matched to the above-described example pattern whereas a signal sample corresponding to values {0.2, −3.1, 3.8} would not.

In one example, each signal pattern 61a-61e has an associated phase error term 62a-62e that is used to produce a phase error at an output 51 of the matching unit 50. In one example, the phase error is fed back to adjust a phase locked loop (PLL) to improve tracking of phase and/or frequency of the signals being read from the tape.

In one example, the phase error term may define a calculation based on parameters such as values of the signal sample and/or system parameters associated with the tape data storage system 100 or read head 110. In one example, the phase error term may be a fixed value or a value selected from a set, the selection being dependent on attributes of the signal sample.

In one example, a signal sample may be matched against multiple signal patterns, the phase error term from each matched signal pattern being taken into account when calculating a phase error produced at the output 51.

In one example, the cumulative phase error is averaged for the number of matches (so if the signal sample matches 3 signal patterns the sum of the phase error of the 3 phase error terms is then divided by 3 to produce an average phase error to be output at the output 51). In one example, each signal pattern may have a weighting associated with it and, upon a signal sample being matched to multiple signal patterns, a weighted average of the phase error terms is calculated and output as the output 51.

In one example, the signal patterns may be associated with a tree structure, the matching unit performing a tree search of the tree structure to match a signal sample against a signal pattern.

In one example, the matching unit is or includes a Viterbi detector or a slicer. In another example, the signal timing recovery system 10 comprises computer program instructions encoded in a memory and executable by a processor of the tape data storage system 100 to process the signal sample and match to signal patterns as set out above. In one example, the processor is a semiconductor-based microprocessor that executes commands stored in the memory. In one example, the memory includes any one of or a combination of volatile memory elements (e.g., RAM modules) and non-volatile memory elements (e.g., hard disk, ROM modules, etc.).

In another example, the matching unit comprises an Application Specific Integrated Circuit (ASIC) or a Field Programmable Gate Array (FPGA).

It will be appreciated that other methods of representing and navigating the search space and of calculating contributions of phase error terms may be used.

In one example, each signal pattern in the data repository 65 encodes a state flag 63a-63f that is taken into account by the matching unit 50.

In one example, the state flag may have a value of enabled or disabled (for example, 1 or 0), a value of enabled (1) indicating that the signal pattern may be matched against a signal sample and a value of disabled (0) indicating that the signal pattern may not be matched against a signal pattern. In one example, a state flag of disabled causes the Matching unit to skip the signal pattern without attempting to match the signal pattern to the signal sample.

In another example, the state flag may have a value of “suppress” indicating that a phase error term of the pattern should be suppressed and should not contribute to the outputted phase error at the output 51 or “enable” indicating that the phase error term of the pattern should contribute to the outputted phase error at the output 51 upon the signal pattern being matched.

In another example, the state flag may be a tri-state flag with each signal pattern having a possible state of: “enable” (for example the value 1); “disable” (for example the value 0): or “suppress” (for example the value −1). In this example a signal pattern may be enabled—available to be matched and contribute to the phase error; disabled—not available to be matched (and therefore not contributing to the phase error calculation); or suppress—available to be matched but not contributing to phase error calculation.

In one example, the timing recovery system 10 includes a controller 70 to maintain state flags for the signal patterns.

In one example, the controller changes flag states for one or more of the signal patterns based on matches of the current signal sample being processed by the matching unit. In another example, the controller records data on prior single samples and/or signal patterns matched in a memory and changes flag states for one or more of the signal patterns based on the data in the memory and on the current signal sample being processed.

In one example, the signal patterns and/or the flag states for the signal patterns may be user-programmable. In one example, the signal patterns and/or the flag states for the signal patterns may be readable and/or writeable by systems of the system that are not parts of the timing recovery system 10.

In one example, the controller is part of the matching unit 50. In one example, control logic may be encoded with data on the signal patterns and the matching unit may execute the logic for a signal pattern upon making a match. For example, as well data defining the phase error contribution a signal pattern may also encode data on actions to be taken following a match (such as whether to enable, disable or suppress the pattern or other patterns).

In one example, the controller and/or the state flags may be implemented as a state machine with state changes being responsive to matches of patterns, each state in the state machine defining possible state changes corresponding to patterns available for matching.

In one example, the flag states may be values of a register or programmable hardware logic elements. In one example, two separate state flags may be provided for each pattern, one for enabling/disabling the pattern and one for suppressing the pattern's phase error term.

Although FIG. 2 is discussed in the context of a read arrangement of magnetic tape data storage system, timing recovery may be applied elsewhere according to various examples such as in receiver for a data communications channel, a data stream synchronizer, a read arrangement for a disk drive.

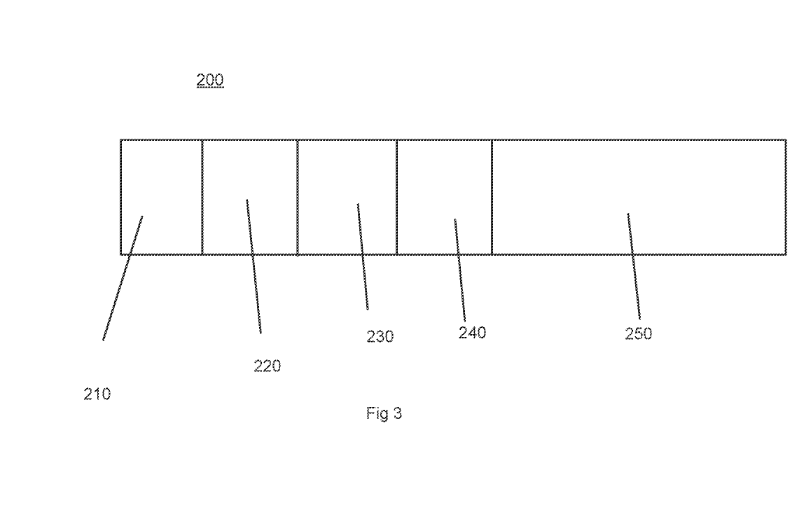

FIG. 3 is a block diagram of an example data stream encoded on a magnetic tape. FIG. 3 includes particular components, modules, etc. according to various examples. However, in different examples, more, fewer, and/or other components, modules, arrangements of components/modules, etc. may be used according to the teachings described herein. In addition, various components, modules, etc. described herein may be implemented as one or more electronic circuits, software modules, hardware modules, special purpose hardware (e.g., application specific hardware, application specific integrated circuits (ASICs), embedded controllers, hardwired circuitry, Field Programmable Gate Arrays (FPGA), etc.), or some combination of these.

FIG. 3 shows an example data stream illustrating selected data fields that may be encoded on a magnetic data tape such as a LTO format tape.

In one example, the data stream 200 includes a Data Set Separator (DSS) field 210, a Variable Frequency Oscillator (VFO) field 220, a Sync field 230, a Header field 240 and a Data field 250.

In one example, patterns associated with the fields are used to when defining the signal patterns. For example, DSS data in a signal may appear pulse-like and have a 12 bit spacing while a VFO field may resemble a sine wave and have a period of 4 bits.

In one example, the signal patterns and their selection for availability in matching by the controller 70 may take into account the expected nature in which a data stream varies. For example, one subset of patterns may provide the strongest phase detector for a data stream containing a regular tone, for example 2 T, than for a data stream containing spectrally rich data.

In one example, a different subset of allowed patterns may be configured for each format field that is anticipated in the data stream. For example, the superset of allowable patterns might be represented by {a, b, c, d, e, f, g}. The controller 70 may be configured to allow (enable) patterns {a, b, c} when a VFO field (2 T tone) is expected and patterns {c, d, e, f, g} for other format fields.

In one example, a repository 72 may encode data on expected sequences of signal patterns, the controller 70 determining an expected sequence of signal patterns in the repository from the segment of the signal and changing the availability of one or more of the signal patterns of the set of signal patterns in dependence on the determined expected sequence of signal patterns

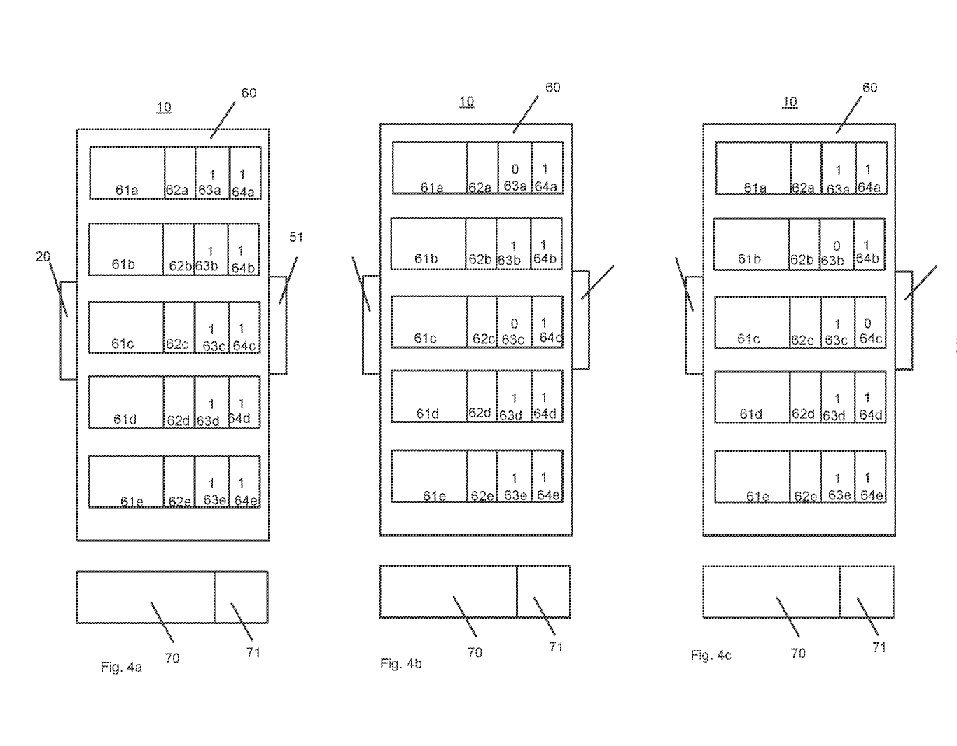

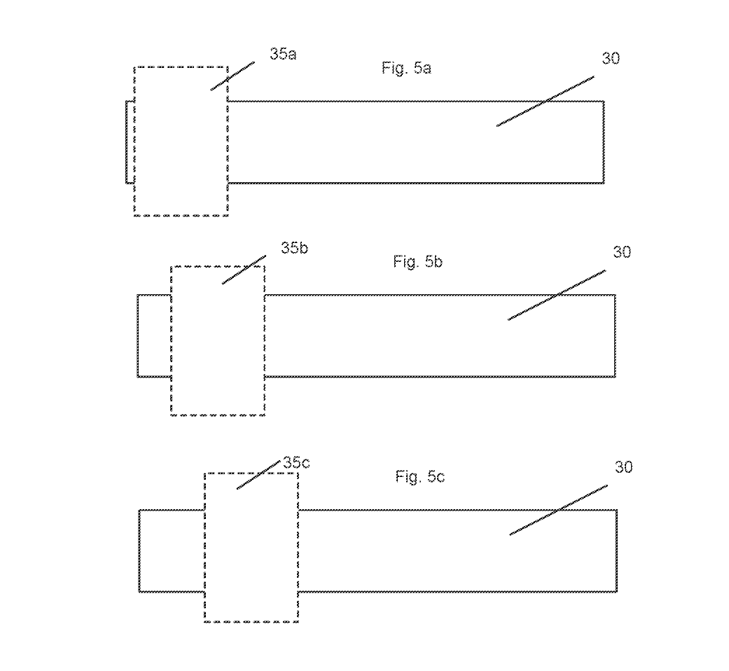

FIGS. 4a-4c are schematic diagrams illustrating states in a signal timing recovery system according to various examples and, FIGS. 5a-5c are schematic diagrams illustrating data being read from an analog data source. In discussing FIGS. 4a-4c and 5a-5c, reference may be made to the diagram of FIG. 3 to provide contextual examples. Implementation, however, is not limited to those examples.

FIGS. 4a-4c and 5a-5c include particular components, modules, etc. according to various examples. However, in different examples, more, fewer, and/or other components, modules, arrangements of components/modules, etc. may be used according to the teachings described herein. In addition, various components, modules, etc. described herein may be implemented as one or more electronic circuits, software modules, hardware modules, special purpose hardware (e.g., application specific hardware, application specific integrated circuits (ASICs), embedded controllers, hardwired circuitry, Field Programmable Gate Arrays (FPGA), etc.), or some combination of these.

FIG. 4a shows a signal timing recovery system 10 having a set 60 of signal patterns 61a-61e with corresponding phase error terms 62a-62e and enable/disable state flags 63a-63e and suppression state flags 64a-64e. In FIG. 4a, all state flags are shown as being enabled meaning that each pattern is available to be matched to a signal 30 received at an input 20 and upon a match occurring, the error term for that respective pattern would contribute to the output made at the output 51.

FIG. 5a shows the signal 30 being received at the input 20 and a first window position 35a of the signal under consideration. The signal patterns are considered in turn and as all of the enable/disable state flags 63a-63e are set to the enabled state, all signal patterns are considered. In this example, the attributes of the signal in the first window position 35a happen to match to the first signal pattern 61a. The signal timing recovery system 10 therefore calculates the phase error from the corresponding phase error term 62a and outputs this at the output 51.

A controller 70 monitors matches taking place. Upon detecting the match against the first signal pattern 61a, the controller cross-references a state table 71 which encodes a pattern mask designating the states of state flags to be set upon a particular match taking place. In this example, the state table designates that the enable/disable flags for the first 61a and third 61c signal patterns should be set to disable. The controller 70 updates the respective state flags 63a, 63c accordingly as is shown in FIG. 4b.

The window is advanced along the signal to a second window position 35b as is shown in FIG. 5b. The signal patterns are again considered in turn but as the enable/disable state flags 63a and 63c are set to disabled, the corresponding patterns are skipped. In this example, the attributes of the signal in the second window position 35b happen to match both the second and the final signal patterns 61b and 61e. The signal timing recovery system 10 therefore calculates the phase error from the corresponding phase error terms 62b and 62e and outputs the average of the sum of these at the output 51.

To illustrate, in one example, it may be that the combination of matches of patterns 61b and 61e is known to be indicative of a strong off-phase signal. In this situation, controller 70 cross-references the state table to obtain the pattern mask corresponding to a match of patterns 61b and 61e following a match to pattern 61a. The mask, for example, designates that the first 61a, third 61c and fourth 61d signal patterns should be enabled; the second signal pattern 61b be disabled and the contribution to phase error by the third signal pattern 61c be suppressed. The controller 70 therefore updates the state flags accordingly resulting in the state shown in FIG. 4c.

The window is advanced in along the signal to a third window position 35c as is shown in FIG. 5c. The signal patterns are again considered in turn, skipping the second pattern as its enable/disable flag is set to disabled but considering all other patterns. Should a match to the third signal pattern 61c be made, no contribution to the phase error is made by its term as its phase error term flag is set to disable and this calculation is therefore skipped.

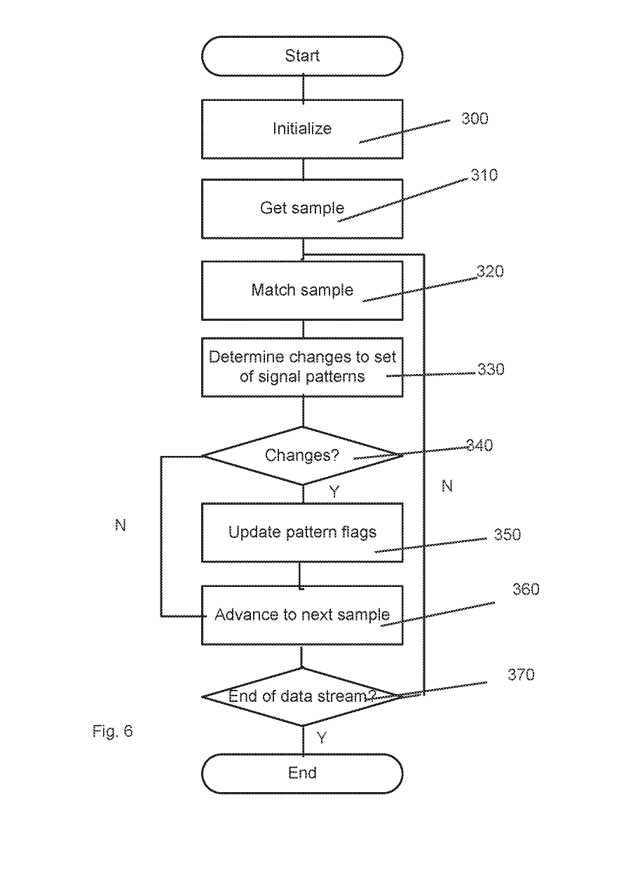

FIG. 6 is a flow diagram depicting steps taken to implement various examples. In discussing FIG. 6, reference may be made to the diagrams of FIGS. 1, 2, 3, 4a-4c and 5a-5c to provide contextual examples. Implementation, however, is not limited to those examples.

FIG. 6 is a flow diagram depicting steps taken to implement various examples. At block 300, default initial states for each signal pattern of a set of signal patterns are set, the default initial state enabling at least a subset of the signal patterns. At block 310, a window is moved to an initial position over a data stream that is being received. At block 320, the segment of the data stream corresponding to the window position is matched against enabled signal patterns. At block 330, a phase error is calculated using a phase error calculation term associated with each matched signal pattern.

Continuing at block 340, it is determined from the matched patterns whether to enable or disable one or more of the signal patterns and if any state changes are determined to be needed, the states are changed in block 350.

Continuing at block 360, the window is advanced forward along the data stream by a step (in one example the step size being such that a portion of the data stream previously considered is still within the window) and determination is made if the end of the data stream has been reached at block 370. If the end of the data stream has not been reached, the method continues at block 320.

The functions and operations described with respect to, for example, the matching unit and controller may be implemented as a computer-readable storage medium containing instructions executed by a processor and stored in a memory. The processor may represent generally any instruction execution system, such as a computer/processor based system or an ASIC (Application Specific Integrated Circuit), a Field Programmable Gate Array (FPGA), a computer, or other system that can fetch or obtain instructions or logic stored in memory and execute the instructions or logic contained therein. Memory represents generally any memory configured to store program instructions and other data.

Various modifications may be made to the disclosed examples and implementations without departing from their scope. Therefore, the illustrations and examples herein should be construed in an illustrative, and not a restrictive, sense.

What is claimed is:

1. A system to process a partial response channel, the system comprising:
an input to receive a signal from a partial response channel; and,
a matching unit to match one or more available ones of a set of signal patterns to a segment of the signal; and
a controller to change the availability of one or more of the signal patterns of the set of signal patterns to the matching unit for a subsequent segment of the signal.

2. The system of claim 1, further comprising a memory to encode availability data on each of the set of signal patterns, the controller including a processor to execute computer program code to write to the memory to change the availability data on the one or more of the signal patterns.

3. The system of claim 2, wherein the matching unit is connected to the memory to read the availability data and determine available ones of the set of signal patterns.

4. The system of claim 1, further comprising an output and a processor, wherein each signal pattern has a phase error term and the processor executes computer program code to calculate a phase error from the phase error term of each matched signal pattern and output the calculated phase error at the output.

5. The system of claim 4, wherein the processor further executes computer program code, upon multiple signal patterns matching the segment of the signal, to determine a contribution to calculated the phase error from the phase error term for each matched signal pattern.

6. The system of claim 5, further comprising a memory to encode an enable or disable state for the phase error term of each signal pattern, the processor further executing computer program code to read the memory for the phase error term of each matched signal pattern and suppress a contribution to the calculated phase error for a phase error term not having an enable state.

7. The system of claim 1, further comprising a repository to encode data on expected sequences of signal patterns, the controller including a processor executing computer program code to determine an expected sequence of signal patterns in the repository from the segment of the signal and to execute computer program code to change the availability of one or more of the signal patterns of the set of signal patterns to the matching unit for a subsequent segment of the signal in dependence on the determined expected sequence of signal patterns.

8. A non-transitory computer-readable storage medium containing instructions to process a partial response channel signal, the instructions when executed by a processor causing the processor to:
match a sample of the partial response channel signal to one or more signal patterns of a set of signal patterns, each signal pattern encoding timing and signal amplitude to be matched against; and
change the set of signal patterns for a subsequent sample of the signal.

9. The non-transitory computer-readable storage medium of claim 8, further comprising instructions which, when executed by a processor, cause the processor to calculate a phase error from the signal sample for each matched signal pattern.

10. The non-transitory computer-readable storage medium of claim 9, further comprising instructions which, when executed by a processor, cause the processor to calculate the phase error from a phase error term associated with a matched signal pattern.

11. The non-transitory computer-readable storage medium of claim 10, wherein each signal pattern encodes an enable or disable state for its associated phase error term, the non-transitory computer-readable medium further comprising instructions which, when executed by a processor, cause the processor to determine the encoded enable or disable state for the phase error term of each matched signal pattern and skip calculating the phase error for a phase error term having a disable state.

12. The non-transitory computer-readable storage medium of claim 8, further comprising instructions which, when executed by a processor, cause the processor to change the set of signal patterns to comprise signal patterns representing signals predicted to follow a signal represented by a currently matched signal pattern or signal patterns.

13. The non-transitory computer-readable storage medium of claim 8, further comprising instructions which, when executed by a processor, cause the processor to change the set of signal patterns to comprise signal patterns representing signals predicted to follow a signal sequence represented by a currently matched signal pattern or signal patterns and a number of previously matched signal patterns.

14. A method for processing a partial response channel comprising:
i) applying a window to sample the partial response channel;
ii) matching the sample to one or more signal patterns of a set of signal patterns to classify the sample as a data type corresponding to the matched one or more signal patterns;
iii) changing the set of signal patterns;
iv) advancing the window along the partial response channel to obtain a further sample; and
v) repeating ii), iii) and iv) in sequence until the window reaches an end of the partial response channel.

15. The method of claim 14, wherein step ii) further comprises calculating a phase error from each matched signal pattern.
